(19) United States
(12) Patent Application Publication
(10) Pub. No.: US 2015/0350038 A1
(43) Pub. Date: Dec. 3, 2015

(54) METHODS OF GENERATING COMMUNITY TRUST VALUES FOR COMMUNITIES OF NODES IN A NETWORK AND RELATED SYSTEMS

(71) Applicant: Telefonaktiebolaget L M Ericsson (publ), Stockholm (SE)

(72) Inventors: Saravanan MOHAN, Chennai (IN); Jaganathan Prasad Nandhini, Chennai (IN); Srinivasan Nandhini, Kumbakonam (IN)

(73) Assignee: Telefonaktiebolaget L M Ericsson (publ), Stockholm (SE)

(21) Appl. No.: 14/287,455

(22) Filed: May 27, 2014

(51) Int. Cl. H04L 12/26; H04L 12/24; H04L 29/08

(52) U.S. Cl. CPC H04L 43/04; H04L 67/16; H04L 41/5041

(57) ABSTRACT

A method of evaluating trust in a network may include defining a community of nodes of the network from a larger set of nodes of the network. A respective individual trust value may be generated for each node of the community of nodes, and a community trust value may be generated based on the individual trust values of nodes of the community. Related systems are also discussed.

### TECHNICAL FIELD

The present disclosure is directed to communications and, more particularly, to communication networks and related systems.

### BACKGROUND

Trust is a phenomenon in human interactions that may be significant in various social settings. Trust is an attitude that may be defined as one individual's behavioral reliance on another. Trust has been identified as a key element of successful conflict resolution (including negotiation and mediation) among members of a group. Performance of a group (also referred to as a community) may depend on trust among members of the group. Different aspects of trust have been studied across different domains. Moreover trust may be associated with enhanced co-operation, information sharing, and/or problem solving.

Now, computation, evolution, and/or prediction of trust in large online networks are gaining prominence. Establishing trust among indirectly connected users may play a significant/vital role in improving a quality of social network services and/or enforcing security. Improved methods of evaluating trust between network nodes and/or among communities of network nodes may thus be useful to provide enhanced understanding of network operations, operations between nodes, relationships between nodes, etc.

### SUMMARY

According to first embodiments disclosed herein, methods of evaluating trust in a network may be provided. A community of nodes of the network are defined from a larger set of nodes of the network. A respective individual trust value is generated for each node of the community of nodes, and a community trust value is generated based on the individual trust values of nodes of the community.

By evaluating trust of different communities of nodes in a network, a network operator may be able to more efficiently operate the network, provide better service, and/or increase profit. The network operator, for example, may be able to selectively provide a particular service and/or a particular communication for nodes of more/less highly trusted communities.

Generating the community trust value may include generating the community trust value as an average of the individual trust values of the nodes of the community.

Defining the community may include defining a first community of nodes, and generating the community trust value may include generating a first community trust value based on the individual trust values of the nodes of the first community. In addition, a second community of nodes may be defined from the larger set of nodes operating in the network, a respective individual trust value may be generated for each node of the second community of nodes, and a second community trust value may be generated based on the individual trust values of nodes of the second community. Responsive to a difference between the first and second community trust values, a service may be selectively provided for nodes of the first community without providing the service for nodes of second community, and/or a communication may be selectively transmitted for the nodes of the first community without transmitting the communication for the nodes of second community. Moreover, nodes of the first and second communities are mutually exclusive.

Defining the community of nodes may include defining a first community of nodes for a first time period of a day, generating the respective individual trust values may include generating the respective individual trust values for each node of the first community of nodes for the first time period of the day, and generating the community trust value may include generating a first community trust value for the first time period of the day. A second community of nodes may be defined from the larger set of nodes operating in the network for a second period of the day, wherein at least one node of the first and second communities is the same and wherein some nodes of the first and second communities are different. A respective individual trust value may be generated for each node of the second community of nodes for the second time period of the day, and a second community trust value may be generated based on the individual trust values of nodes of the second community for the second time period of the day. A first node may be included in the first and second communities of nodes, and a second node may be included in the first community and excluded from the second community. A third node may be included in the second community and excluded from the first community.

According to some other embodiments, a computer system may include a processor, and memory coupled to the processor. The memory may include computer readable program code that when executed by the processor causes the processor to perform operations including: defining a community of nodes of the network from a larger set of nodes of the network; generating a respective individual trust value for each node of the community of nodes; and generating a community trust value based on the individual trust values of nodes of the community.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of inventive concepts. In the drawings:

FIG. 1A is block diagram of a communication network that is configured according to some embodiments;

FIG. 1B is a schematic diagram illustrating communications between nodes of a communication network according to some embodiments;

FIGS. 2, 3A, 3B, 4A, 4B, and 5 are flow charts illustrating operations of evaluating trust according to some embodiments;

FIGS. 6A and 6B are graphs illustrating profit and trust for different communities of nodes at different times according to some embodiments;

FIG. 6C is a bar graph illustrating changes in trust values over time for different communities of nodes according to some embodiments;

FIG. 7 is a flow chart illustrating operations designating trusted/untrusted communities of nodes according to some embodiments; and

FIG. 8 is a block diagram illustrating an evaluation system according to some embodiments.

### DETAILED DESCRIPTION

Inventive concepts will now be described more fully hereinafter with reference to the accompanying drawings, in which examples of embodiments of inventive concepts are shown. These inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

For purposes of illustration and explanation only, these and other embodiments of present inventive concepts are described herein in the context of operating in a RAN that communicates over radio communication channels with wireless terminals (also referred to as mobile stations, user equipment, or UEs). It will be understood, however, that present inventive concepts are not limited to such embodiments and may be embodied generally in any type of network. As used herein, a wireless terminal (also referred to as a node, a mobile station, user equipment, or UE) can include any device that receives data from a communication network, and may include, but is not limited to, a mobile telephone (“cellular” telephone), laptop/portable computer, pocket computer, hand-held computer, desktop computer, and/or a machine-type communications (MTC) device.

As used herein, the term node may include a wireless terminal of a radio access network, a user account for a wireless terminal of a radio access network, a user account of a social media network, etc. Because a node is operated/owned/used by an operator/owner/user of the node (i.e., a person), trust in a node may be representative of a trust in the operator/owner/user of the node.

In some embodiments of a RAN, several base station subsystems can be connected (e.g., by landlines or radio channels) to a radio network controller (RNC). The radio network controller, also sometimes termed a base station controller (BSC), supervises and coordinates various activities of the plural base station subsystems connected thereto. The radio network controller is typically connected to one or more core networks.

General Packet Radio Service (GPRS) Enhanced Data Rates for the Global System for Mobile Communications (EDGE) Radio Access Networks (also referred to as GERANs) evolved from the Global System for Mobile Communications (GSM). Note that although terminology from 3GPP (3^{rd} Generation Partnership Project) GERAN is used in this disclosure to exemplify embodiments of inventive concepts, this should not be seen as limiting the scope of inventive concepts to only these systems. Other wireless systems, including LTE (Long Term Evolution), WCDMA (Wideband Code Division Multiple Access), WiMax (Worldwide Interoperability for Microwave Access), UMB (Ultra Mobile Broadband), HSDPA (High-Speed Downlink Packet Access), GSM (Global System for Mobile Communications), etc., may also benefit from exploiting embodiments of present inventive concepts disclosed herein.

Also note that terminology such as base station subsystem (e.g., BSS, base station, NodeB, eNodeB, or Evolved Node B) and wireless terminal (e.g., WT, mobile station, UE, or User Equipment) should be considered non-limiting and does not imply a certain hierarchical relation between the two. In general, a base station subsystem (e.g., a BSS) and a wireless terminal (e.g., an WT) are considered as examples of respective different communications devices that communicate with each other over a wireless radio channel.

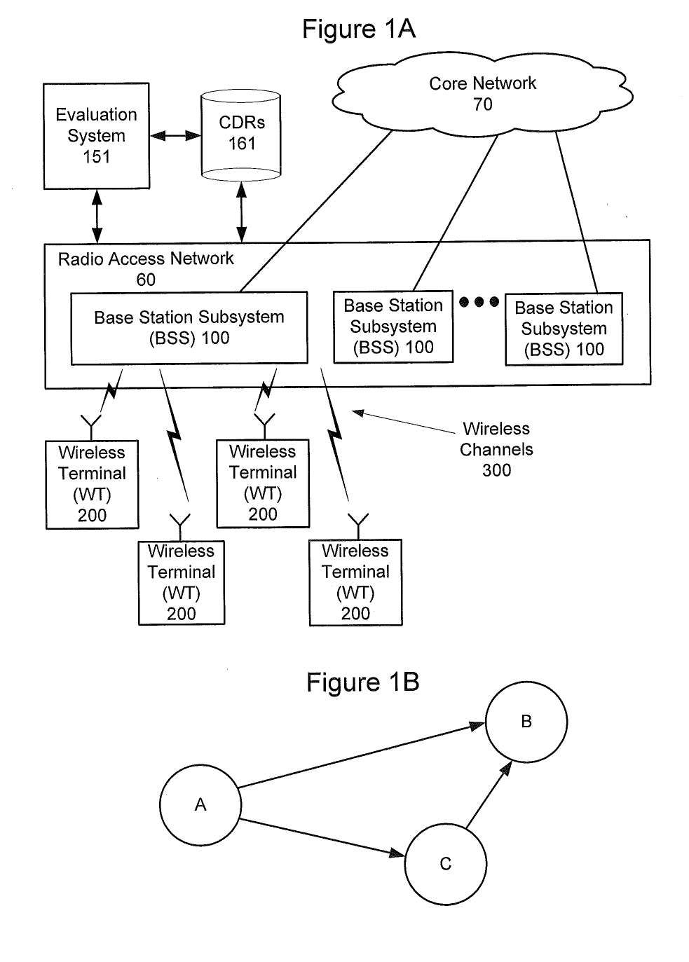

FIG. 1A is a block diagram of a communication system that is configured to operate according to some embodiments of present inventive concepts. An example radio access network 60 (also referred to as a cellular radio network, a cellular mobile network, a cellular telecommunication network, a cellular network, etc.) is shown that can be a GERAN. Radio base station subsystems BSSs 100 can be connected directly to one or more core networks 70. Radio base station subsystems 100 communicate over wireless channels 300 with wireless terminals WTs (also referred to as mobile stations, user equipment nodes, or UEs) 200 that are within their respective communication service cells (also referred to as coverage areas). The radio base station subsystems (BSSs) 100 can communicate with one another and/or with the core network(s) 70 through respective interfaces, as is well known to one who is skilled in the art.

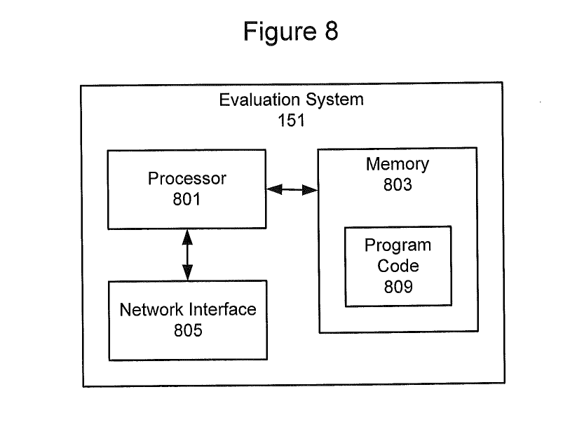

As further shown in FIG. 1A, an evaluation system 151 and a database of call data records CDRs 161 may be provided for RAN 60. As discussed in greater detail below, evaluation system 151 may be used to generate trust values for individual nodes (e.g., wireless terminals) of the network based on information from the database of CDRs 161. More particularly, FIG. 8 is a block diagram of evaluation system 151 including processor 801, network interface 805, and memory 803 (including program code 809). Network interface 805 may provide a communication interface between processor 801 and elements of network 60 (e.g., base station subsystems 100), core network 70, and/or the database of CDRs 161. Memory 803 may be coupled to processor 801, and program code 809 may provide code/instructions used by processor 801 to perform operations as discussed in greater detail below. While the database of CDRs 161 is shown separate from evaluation system 151, the database of CDRs 161 may be saved in memory 803 of evaluation system 151 according to some embodiments. Moreover, evaluation system 151 and/or the database of CDRs 161 and/or elements thereof may be provided separate from radio access network 60 and core network 70, as an element(s) of radio access network 60, as an element(s) of core network 70, etc.

Models for evolution of trust may be important to cellular mobile network operators to improve customer services, to study collective action and/or social mobilization of recommendations, and/to improve loyalty among members of groups within the cellular network. Moreover, trust and trust metrics may be computed to evaluate trust relationships between individuals when they communicate or meet.

Even though social networks and cellular mobile telecom networks may be similar in many ways, trust models available for social networks may not be compatible with cellular mobile networks. Trust models for social networks, for example, may focus mainly on propagation of trust in the network based on the concept that a ‘Friend of a Friend is a Friend’. In a social network, a network of a member's friend may be visible to the member so that the member may be aware of a ‘Friend of a Friend Circle’. In a cellular mobile network, however, this friend of a friend circle may not be known to another member unless the other member asks the friend for a recommendation or suggestion. While social network trust models are discussed in the literature, initialization of trust values (also known as trust bootstrapping) is not known, and more particularly, initialization of trust values appropriate for cellular mobile networks is not known.

Research related to trust in a social networks often deals with propagation of trust scores that already exist among members of the social network. The origination of this trust score, however, may remain a mystery. For example, factors considered to determine trust scores may not be known. Also, when a new member (also referred to as a node) enters a network, known previous work on trust scores concentrates on evaluating the new node's trust depending only on recommendations (propagation) from known nodes even though trust is a behavioral value that may depend mainly on the subject's activities.

Trust metrics have been proposed in the field of game theory, and such metrics have often been based on past interactions and/or belief propagation. In the field of game theory, trust may be defined as a subjective expectation a player has about another player's future behavior based on the history of their encounters. Trust metrics may also be desirable in cellular mobile telecom networks, for example, when evaluating trust between two individual users, and/or when one user wants to know the trustworthiness of another. Available trust frameworks may try to address the question of whether user A (also referred to as node A or member A) can trust user B (also referred to as node B or member B) on a service where both users A and B are aware of each other's actions. In a cellular mobile telecom network, the service provider (also referred to as the network operator) may want to determine/know a trustworthiness of an entire community of users and of individual users of the community. In a cellular mobile network, only the network operator may be aware of the actions and information of the users/nodes of a community.

For a cellular mobile network service provider (also referred to as a cellular mobile network operator), retaining existing users/customers may be desirable/important. To retain users/customers, it may be useful for a network operator to gather and analyze factors that encourage an existing user to move out of the network and/or to stay in the network. Evaluating Trust may effectively serve this purpose by identifying users with a higher probability of moving out of the network. Determining trust scores among the users/customers of a cellular mobile network, however, may be difficult, and it may involve the monitoring of events happening between users/customers over a period of time.

According to some embodiments of inventive concepts, trust may be evaluated among nodes (also referred to as members, customers, users, etc.) of communities (also referred to as groups) of the cellular mobile telecom network, and more/less trusted communities may be determined as follows:
Calculate trust dimensions as a whole for the community which depends on time of existence, communication, and existence of greater/lesser numbers of strong links and/or location;
Evaluate trust between community members from the network operator's point of view; and/or
Evaluate roles of a new member in a community.

Nodes (also referred to as users) in a cellular mobile telecom network (or other network) may generally be defined as belonging to communities (also referred to as groups) of nodes. One node may belong to one or more different communities at/during respective different time periods (e.g., morning, afternoon, and evening, or weekday and weekend). A node may be relatively strongly connected to other nodes within the node's community and relatively weakly connected with nodes of other communities. Identification of such existing communities may provide an initial visualization used to develop a trust model.

Communities may vary chronologically, geographically, and/or sociologically. First, a community of nodes may not be the same for a whole day. Variations may be observed between communities that are defined and/or exist during morning, afternoon, evening and night. For example, business and work related calls may happen during the afternoon, while calls between family members may happen mostly during the evening, and calls to friends may occur during the night. Second, communities can be based on locations associated with both ends of communications. People who are connected with each other and who are associated with a same/similar location may be assumed to have stronger bonds than connected people who are associated with different locations. Third, more influential people and/or those with higher reputations may be given higher rankings compared to other users because influence and/or reputation may play significant roles in building trust.

If node A (also referred to as user A, member A, or customer A) communicates with node B (also referred to as user B, member B, or customer B), node A may be assumed to have some trust in node B, and the trust may be estimated/calculated as a node A to node B trust value (also referred to as an AtoB trust value). In a community of customers, there may be many such node A's that communicate with node B. From the network operator's point of view, to evaluate a Trust value that node B has earned from peers in the community, it may be useful/necessary to determine all such A to B trust values. Stated in other words, a trust value for node B may be based on AtoB trust values for all other nodes that communicate with node B.

According to some embodiments of inventive concepts, communities of nodes (also referred to as customers) may be identified for a period of time and trust bootstrapping may be performed to calculate relevant trust metrics from different perspectives for each node and for overall communities of nodes. Moreover, measures may be provided to calculate local community (group) trust metrics in comparison with profits provided by the respective local communities to the network operator, and two (or more) different communities (e.g., high trust and low trust communities) may be identified which may help the network operator provide improved/better targeted up-selling to costumers of the different communities. These trust metrics may thus provide opportunities for the network operator to retain customers and/or to understand a value of a new customer role in a community. Such trust metrics may also be used in social networks to identify intruders.

An environment for Trust calculation may be identified. Trust may be a dyadic relation among nodes (users, members, or customers) in a community. Trust may be quantified with a value to indicate possible future behavior of a node (user, member, or customer) as expected by other nodes (users, members, or customers) in the community based on past dyadic relations the node had with other nodes of the community.

A mobile cellular telecom network may include a plurality of nodes (users, members, or customers) with various different characteristics. Each customer may be considered as a node and communications in one direction between any pair of nodes may be considered as an edge. Information (also referred to as metadata) regarding each communication between nodes may available in the database of CDRs (Call Detail Records) 161. A customer profile (also referred to as a node profile) of each customer may also be useful to calculate a trust value for each node. To effectively calculate a Trust value of a particular node, the node may need to exist in the network for at least three months before tracking the node's usage behavior.

Call Detail Records may provide a repository of information (also referred to as metadata) about all communications between nodes in a network. Call Detail Records may include fields such as source (e.g., an identification of the originating node, or the calling node), destination (e.g., an identification of the receiving node, or called node), duration (e.g., a length of the call), location, type (e.g., voice or SMS), time stamp (e.g., a time that the call started), direction, plan, etc. Initial stages may include pre-processing of CDRs to generate a frequency table (i.e., to generate a table identifying a number of times a particular node of the network has called other nodes in the network that the node is in contact with). In addition, an indegree and an outdegree may be determined for each user in the network. To determine a Trust value associated with a call, the source field, destination field, duration field, and location field of the respective CDR for the call may be considered because these factors may greatly influence and/or affect the Trust value. The source field of the respective CDR may represent the node that initiated the call (e.g., an identification of the calling node, such as a telephone number, serial number, account number, etc.) and the destination field of the respective CDR may represent the node for which the call is intended (e.g., an identification of the called node, such as a telephone number, serial number, account number, etc.). The duration field of the respective CDR may represent a length of the call, and the location field may represent the base station subsystem (BSS or base station) antennae serving the node which initiated the call (e.g., an identification of the base station antenna serving the calling node).

Gephi is a Graph tool that may be used to identify communities of nodes. Gephi may be used to calculate frequencies (also referred to as weights) of all edges along with source and target/destination nodes of each edge. According to some embodiments, communications from node A to node B may define a first edge associated with communications between nodes A and B, and communications from node B to node A may define a second edge associated with communications between nodes A and B. Accordingly, for each pair of nodes A and B in a network, two edges may be defined, and separate frequencies may be calculated for each edge. Modularity statistics may be used to analyze the network, and this analysis may be used to generate communities and/or to assign a Modularity (mod) class to each node. A modularity class (abbreviated as “mod”) may thus be an identification for a community of nodes.

Trust may be evaluated for each individual node. To evaluate an individual Trust value for each node, a value of a Trust that each node in the network has with respect to other nodes in the network may be evaluated. Factors that affect and/or influence Trust may include Duration, Reputation, Influence, Domain Interest, Field of Work, and Location. Factors like duration, reputation, and influence may be obtained directly and/or by pre-processing CDRs. Values of indegree and degree obtained by pre-processing CDRs may represent reputation and influence, respectively. Once a Trust value that a source node (trustor) has on a destination node (trustee) is obtained, Trust values may be aggregated to provide an aggregate Trust value for each Trustee node in the network.

A community trust may be evaluated based on trust values for each node in the community. Different nodes may be included in different communities depending on weight(s) of the communications. Nodes in the network may thus be divided into smaller communities of nodes. The cellular mobile network may thus be divided into distinct communities of nodes identified by forming smaller groups of nodes within all of the nodes of the network. Nodes (representing users, members, and/or customers) within a community may be relatively strongly connected with other nodes in the same community and relatively weakly connected to nodes in other communities. A community trust value for each community may be calculated from trust values of each node that belongs to that community. A mean aggregate or average of individual node trusts may be used to provide the community's trust value.

Each community in a network may be designated as a trusted community or an untrusted community. Once a Trust value is generated/calculated for each community, each community can be designated as a trusted community or as an un-trusted community based on a certain threshold trust value. These communities may be further analyzed to identify factors that differentiate them as trusted and untrusted communities. This analysis may be helpful for service providers to take steps to increase Trust values for Un-Trusted communities.

Trust formation and/or evaluation may be provided in cellular mobile telecom networks. Social interactions, may be significant indicators in the formation of trust, and a certain level of socialization threshold may need to be met for trust to develop between two individuals. In this regard, the parameters identified below (frequency, duration, field of work, domain interest, reputation, influence, and location) may be derived to analyze communications between two different nodes.

In a community, frequency may define how often one user contacts another. Communications between any two nodes in the network can happen ‘n’ times in both directions. Reciprocating communications may be more meaningful/worthy than unidirectional communications for the calculation of trust. Regarding nodes A and B, a first frequency may be calculated as a number of times node A calls node B (defining a first communications edge with node A as source and node B as destination) over a period of time, and a second frequency may be calculated as a number of times node B calls node A (defining a second communications edge with node B as source and node A as destination) over the period of time. For example, node A may contact/call node B ‘m’ times during the period of time so that the first frequency is ‘m,’ and node B may contact/call node A ‘1’ times during the period of time so that the second frequency is ‘1.’ Variables ‘m’ and ‘1’ may thus be respective frequencies for different communication edges between nodes A and B.

A duration between any two nodes of a community may be a sum of durations of calls between the nodes in time units during a period of time. If the CDRs include records for 3 communications involving nodes A and B of call lengths 100 seconds, 200 seconds and 300 seconds, then the duration of communication between these two nodes A and B may be 600 seconds. According to some embodiments, different durations may be calculated for the different edges of two nodes. For example, a first duration may be calculated as a sum of durations of calls of a first edge including calls from node A to node B during the time period, and a second duration may be calculated as a sum of durations of calls of a second edge including calls from node B to node A during the time period.

Users who belong to or are involved with a same project, a same office, a same college/school, etc. may share a same work interest, referred to as a field or work (e.g., if node A and node B are working on a same project, they may share a common interest of work). Even people involved in different projects or work may share interest in a specific technical field(s). For example, both nodes A and B may be interested in a programming language that is useful for their work, and they may tend to discuss the programming language. Accordingly, the field of work may be used to identify different nodes sharing a similar work interest.

Members of a club (e.g., a cricket club) may share news about a day's match. Family events/celebrations may be discussed among family members. Common interests might include general human interests like music, politics, sports, business, markets etc. Accordingly, the domain interest may be used to identify different nodes sharing a similar domain interest.

People with relatively high reputations may generally receive more calls than people with relatively low reputations. People with relatively high reputations may generally be the ones whom others approach to gather information. A node of a person with a relatively high reputation may thus be a good target to inject information into a community. Many incoming communications to a node may be an indication of the node having a relatively high/higher reputation. In a community, a node with a relatively high/highest indegree (i.e., number of incoming edges) may be considered to have a relatively high reputation, and a node with a relatively low/lowest indegree (i.e., number of incoming edges) may be considered to have a relatively low reputation.

Influence may be determined based on both the indegree and outdegree of a node (e.g., considering all the edges that a node is connected to). A higher influence value may thus indicate a high influence that the respective node has on its community and in the network. A greater number of neighbors that a node is connected to may indicate a greater diffusion of information from this node in the community relative to other nodes with fewer connections. Based on the number of inbound and outbound calls, and the number of distinct connections, an influence score can be assigned to each node.

Usually people/nodes in, belonging to, and/or associated with a same location may enjoy lower call rates. Accordingly, nodes may tend to communicate with other nodes in the same location unless the required information is not available among local nodes. Location is not only a matter of trust, but it increases trust affinity as well. In other words, people may spend more time with those they trust and, at the same time, if they start spending time with new people, it is likely that trust relationships will arise and evolve. Location may thus be defined by a zip code, a city, or other location information, for example, associated with a billing address for the owner/user of the node.

Different methods of calculation of Trust among nodes are discussed below with respect to the diagram of FIG. 1B. As shown, node A may be a trustor node, node B may be a trustee node, and node C may be a third party node.

Direct Trust (Td) of a node may be calculated according to the following formula:

Td=tan hΣ(μi*Wi*Pi),

where, μi=+1 or −1 based on the experience, Wi=Weight based on factors, and Pi=Number Of Experiences. Operation tan h (hyperbolic tangent) may be used to evaluate the direct trust value in the range of [0,1].

Recommendation Trust (Tr) for a node may be calculated according to the following formula:

Tr=Td*Vi.

For recommendations from n users, recommendation trust (Tr) may be calculated according to the following formula:

Tr=1/nΣ(Td*Vi),

where, Td is the direct trust node A has on third-party node C, and Vi is the trust value calculated by node C for trustee B.

Combination of both these trusts may be used/required to evaluate an actual trust value as indicated in the following equation:

V=Td+(1−|Td|)*Tr.

Using this formula may allow weighing between Tr and Td. For example, if the trustor has enough direct information about the trustee (e.g., Td=1, the maximum value), it may outweigh Tr making its coefficient essentially 0. Otherwise, if the trustor has no knowledge about the trustee at all, the actual trust value may depend completely on Tr (as Td is 0).

These calculations may provide all possible node A to node B trust values in the network.

Similarly, there can be any number of source nodes, like node A, that have different trust values for node B. An aggregate mean of these values for node B may give a trust value for the individual node. Details discussed above are explained in greater detail below.

An implementation according to some embodiments is discussed in greater detail below. For example, a cellular mobile telecom network N may include a plurality of communities C of nodes n. More particularly, let N be the mobile telecom network, so that:

N={C₁,C₂,C₃, . . . Cₘ},

where Cᵢ is ith Community and i varies from 1 to m and each community has k members (where k can be different for different communities). Each community C may thus include nodes n as follows:

$${C}_{1} = \{ {n}_{11} , {n}_{12} , {n}_{13} , … {n}_{1 k} \}$$

$${C}_{2} = \{ {n}_{21} , {n}_{22} , {n}_{23} , … {n}_{2 k} \}$$

$${C}_{3} = \{ {n}_{31} , {n}_{32} , {n}_{33} , … {n}_{3 k} \}$$

$$…$$

$${C}_{m} = \{ {n}_{m 1} , {n}_{m 2} , {n}_{m 3} , … {n}_{mk} \} .$$

Generally, the ith community Cᵢ includes a set of k nodes,

Cᵢ={nᵢ₁,nᵢ₂,nᵢ₃, . . . nᵢₖ},

where nᵢⱼ is the jth node of ith community. Moreover, set Wᵢ of trust weights w for respective nodes n of a community i may be,

Wᵢ={wᵢ₁,wᵢ₂,wᵢ₃, . . . wᵢₖ},

where wᵢⱼ is the trust weight of node nᵢⱼ. Accordingly, trust may be calculated as,

$${T}_{ij} ( {n}_{ik} ) = \begin{matrix}\{ {V}_{ij} , if {n}_{ij} trusts {n}_{ik} \\ \{ 0 , otherwise\end{matrix} ,$$

where Vᵢⱼ is the individual trust value that nik gained from nᵢⱼ. Accordingly,

Tᵢₖ={Tᵢ₁(nᵢₖ),Tᵢ₂(nᵢₖ),Tᵢ₃(nᵢₖ), . . . Tᵢₘ(nᵢₖ)}

and Tᵢ={Tᵢ₁,Tᵢ₂,Tᵢ₃, . . . Tᵢₘ},

where Tᵢⱼ is the trust value of individual nodes, and Tᵢ is the trust value of the community.

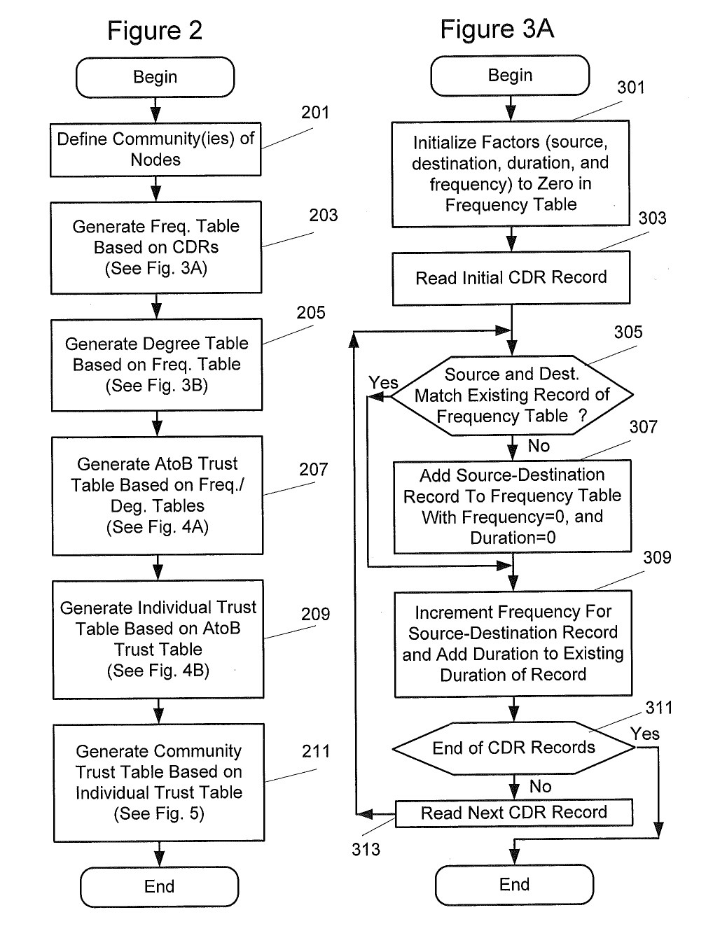

Calculation of trust scores for communities of nodes (e.g., mobile terminals operating in a cellular mobile telecom network) is discussed in greater detail below with respect to the flow chart FIG. 2. More particularly, communities of nodes may be defined at block 201 so that nodes of the network may be separated into different communities, and trust scores may be separately calculated for each community of nodes based on communications between nodes of the respective communities.

According to some embodiments, CDRs may be pre-processed according to the following operations to bootstrap initial trust values for individual nodes of a community of nodes. A frequency table may be generated based on call detail records CDRs at block 203, and a degree table may be generated based on the respective frequency table at block 205. Operations of generating a frequency table and a degree table are discussed below.
Initialize src (source), dst (destination), dur (duration), freq (frequency) to zero
do
Read src, dst, dur for each record from CDR
If (src, dst) already exists
Increment freq by 1
Add dur to the existing value
Else
   freq=1
Write src,dst,freq,dur into frequency table
while(!eof(CDR))
// frequency table consists of Source(src), Destination(dst), Frequency(freq), Duration(dur) for each edge
do
   for each node from nodes table
do
   Initialize indeg, outdeg, deg to 0
   read src, dst from frequency table
   If node equals dst
      Increment indeg by 1
   Otherwise if node equals src
      Increment outdeg by 1
while(!eof(frequency table))
deg=indeg+outdeg
write node,indeg,deg into degree table
while(!eof(nodes table))
// degree table consists of node, mod, indegree (indeg), outdegree (outdeg), degree (deg)
   A frequency table and a degree table may thus be generated with records for each node of the network.

An AtoB trust table may be generated based on the frequency and/or degree tables at block 207, and an individual trust table may be generated based on the respective AtoB trust table at block 209. Operations of generating an AtoB trust table and an individual trust table are discussed below. Accordingly, trust may be evaluated for each node of the network.
do
for each (src, dst, freq, dur) record from frequency table
do
   initialize weight,Trust to 0
Retrieve indeg, deg of dst from degree table
Retrieve field, interest and location of src from User Profile Information
Retrieve field, interest and location of dst from User Profile Information
// User Profile Information contains domain interest (interest), field of
   work (field), location of the nodes
      Compare src and dst attributes and provide binary values to field, interest and location
      if(freq>1 & dur>100)
         weight=aggregate mean (dur, indeg, deg, field, interest, location)
      otherwise
         weight=aggregate mean (dur, indeg, deg,0,0,0)
      Trust=tan h(weight*freq)
   while(!eof(degree table))
   write src, dstn, weight, Trust into AtoB table
while(!eof(frequency table))
// AtoB table contains Source (src), Destination (dstn), Weight(weight), AtoB Trust (Trust)
do
   for each node in nodes table
   do
      initialize inTrust to 0
      read src, dst, Trust in aTob table
      if node equals dst
         increment inTrust by Trust
   while(!eof(aTob table))
   write node, mod, inTrust into indiv table
while(!eof(nodes table))
// indiv table contains node, mod, Individual Trust (inTrust)
   An individual trust table may thus be generated with an entry for each node in the network.

A community trust table may be generated with an entry for each community of nodes based on the individual trust table at block 211. Operations of generating a community trust table for a community of nodes are discussed below, and these operations may be repeated for each community of nodes. Accordingly, trust may be evaluated for each community.
sort indiv table by mod value
initialize commTrust to 0
do
   read node, mod, inTrust from indiv table
   until mod value changes
      increment commTrust by inTrust
   once mod value changes
      commTrust=0
   write mod, commTrust to Output table
while(!eof(indiv table))
// Output table contains mod, Community Trust (commTrust)
   The resulting community trust table may thus include a record for each community of nodes including a community identification (mod), and a community trust value representing an aggregate trust for that community.

A Call Detail Record (CDR) produced by a telephone communication (also referred to as an exchange or transaction) may include attributes that are specific to a single instance of a phone call or other communication such as an SMS (Short Message Service) communication, an MMS (Multimedia Messaging Service) communication, a Video Call communication, etc. that was handled by the network. A CDR for a call/communication may include metadata (i.e., data about data) with data fields that describe a specific instance of a telephone or other communication without including the actual content (e.g., voice, text, video, etc.) of the communication. Actual CDRs may include attributes such as:
Calling party or source (src)—the phone number (also referred to as an identification or serial number) of the node/subscriber originating the call;
Called party or destination (dst)—the phone number (also referred to as an identification or serial number) of the node/subscriber receiving the call;
Date and Time—the starting time of the call;
Call duration (dur);
Billing phone number that is charged for the call;
ID of the telephone exchange writing the record;
Additional digits to route the call;
Disposition of the call;
Route by which the call entered the network;
Route by which the call left the network;
Call type; and/or
Any fault condition encountered.

Attributes considered herein may include the phone number of both the calling and receiving nodes/parties, the duration, and the cost charged for the call. The phone number fields indicate the nodes of the community that are connected by the communication. The duration field provides the length of the communication that can serve as a weighing factor and/or to determine a weighting factor for the communication edge. The CDR may include information about all instances of communications between any two nodes/users of the network. The communication between a pair of nodes may be made unique by adding an extra field ‘Frequency’ providing a repetition count of the instances of communications between the nodes in a given direction. Other useful/required attributes, such as reputation and/or influence of a node, may be derived from the primary attributes discussed above. Some attributes like domain interest, field of work, and/or location of nodes may be obtained from user profile information. A User Profile Gateway may provide a unified way of accessing, managing and transferring static and dynamic user profile data, including personal information, preferences, subscriptions, services, devices, roles, and/or access. Comparing these attribute values of two connected nodes may contribute additionally to the weighing factor for the communication edge connecting these nodes in the community.

To provide sufficient data, CDRs of a community may be considered for a period of time (e.g., 3 consecutive months) before calculating trust values. A first month's data may be used to bootstrap trust values for all nodes existing in the community and to bootstrap trust values for each community. Evolution over a month may occur with addition of new nodes to the community and removal of old nodes from the community. This addition/removal of nodes may have some effect on community trust depending on behavior of the nodes involved. A more trusted community (also referred to as a trusted community) may be a community having a community trust value that is greater than a trust threshold, and such a more trusted community may remain relatively static over time (i.e., relatively fewer existing nodes may move out of the community/network, and relatively newer nodes may show positive behavioral trust). Also, profits earned from a more trusted community of nodes may be relatively higher that profits earned from a less trusted community of nodes. In a less trusted community of nodes (also referred to as an untrusted community) having a trust value below the trust threshold, more nodes may move out of the community and/or newer nodes may find it difficult to establish communications with other nodes. Profits earned from such a less trusted community of nodes may drop over time.

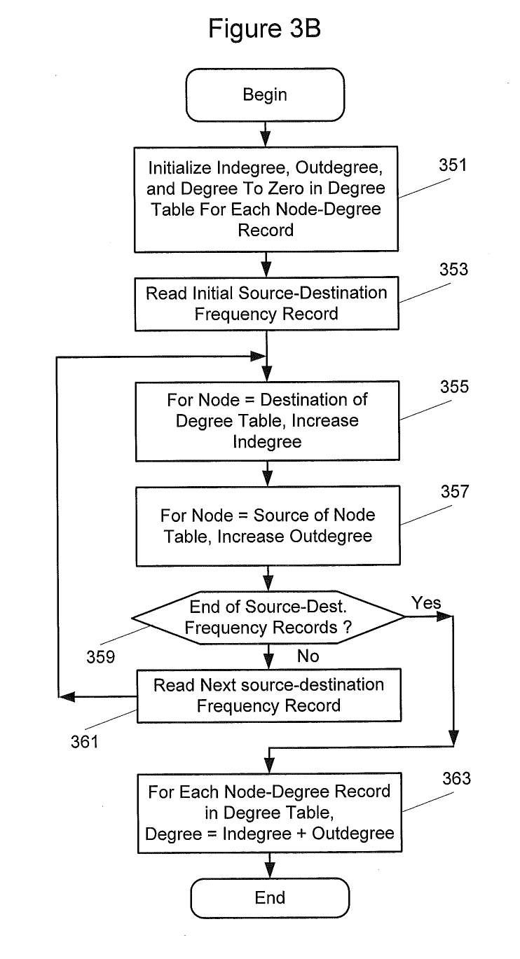

Operations of FIG. 2 will now be discussed in greater detail with respect to the flow charts of FIGS. 3A, 3B, 4A, 4B, and 5, and the block diagram of FIG. 8. As discussed above with respect to FIG. 2, processor 801 may define communities of nodes from the nodes of the network at block 201, and a unique identification (mod) may be assigned to each community of nodes. Stated in other words, the nodes of the network may be divided into a plurality of communities. According to some embodiments, the network may be a mobile communication network 60 including a plurality of base stations 100, and each of the nodes of the network may include/be a respective wireless terminal 200 configured to communicate over a wireless interface with base stations 100 of the mobile communication network. According to some other embodiments, the network may be a social network, and each node may be an account of a user of the social network without association with a particular device or wireless terminal.

At block 203, processor 801 may generate a frequency table for the nodes based on the call data records CDRs from database 161. The resulting frequency table may include an entry/record for each communication edge, with a communication edge being defined by a source node and a destination node. Accordingly, communications between a first node and a second node may include a first communication edge for communications with the first node being the source and the second node being the destination and a second communication edge for communications with the second node being the source and the first node being the destination. Stated in other words, a communication edge may be defined by a pair of nodes and a direction of communication therebetween.

Operations of generating a frequency table for a network of nodes are discussed in greater detail with respect to FIG. 3A. At block 301, processor 801 may initialize elements/fields (e.g., source, destination, duration, frequency, etc.) to zero in the frequency table. At block 303, processor may read an initial call data record CDR for the community of nodes. As discussed above, each call data record in the database of CDRs 161 may include the following fields: source (scr) providing an identification (e.g., telephone number) of the node initiating/originating the communication; destination (dst) providing an identification (e.g., telephone number) of the node receiving the communication; and duration (dur) providing the duration of the communication. For the sake of conciseness, all fields of a call data record are not discussed at this time.

At block 305, processor 801 may determine if the source (scr) and destination (dst) match the source and destination of an existing record in the frequency table. With the initial CDR record of block 303, there will be no match at block 305 because all fields of the frequency table were initialized at block 301. Accordingly, a new record may be added to the frequency table for the initial CDR record at block 307. In particular, the new record will be created with the source (scr) and destination from the CDR entered in the respective fields of the new record for the frequency table and with the frequency and duration remaining 0 for the new frequency table record. At block 309, the frequency for the source-destination frequency record is incremented (to indicate the occurrence of a communication initiated by the source node and received by the destination node) and the duration from the call data record is added to the existing duration for the source-destination frequency record. When processing the initial call data record at blocks 307 and 309, the resulting source-destination frequency record of the frequency table will thus have a frequency of one and a duration equal to that of the initial CDR. For each additional CDR having the same source and destination, the frequency of the corresponding source-destination frequency record will be incremented and the duration of each additional CDR will be added to the duration of the corresponding source-destination frequency record.

At block 311, processor 801 determines if there are additional unprocessed CDRs. If not all of the CDRs have been processed at block 311, processor 801 reads a next CDR at block 313 and repeats operations of blocks 305, 307, 309, and 311 until all of the CDRs have been processed at block 311. For each next CDR from block 313, processor 801 determines at block 305 if the source (scr) and destination (dst) of the current CDR match the source and destination of an existing source-destination frequency record of the frequency table. If there is no match at block 305, a new source-destination frequency record is added to the frequency table at block 307 including the source and destination from the current CDR with a 0 frequency and a 0 duration, the frequency is incremented at block 309, and the duration of the current CDR is provided as the duration at block 309. If there is a match at block 305, the frequency field of the matching source-destination frequency record is incremented (indicating another communication for the edge) and the duration from the current CDR is added to the duration field of the matching source-destination frequency record at block 309. If there is a match at block 305, an additional source-destination frequency record is not needed because the CDR represents another communication for an existing edge.

Processor 801 may repeat operations of blocks 313, 305, 307, 309, and 311 until all CDRs of a the relevant time period have been processed. While not specifically shown in FIG. 3A, processor 801 may consider only CDRs over a relevant time period (e.g., for communications occurring during a 30 day period, a 1 month period, a 90 day period, a three month period, etc.). For example, each CDR may include a time stamp field indicating a date and time of the respective communication, and processor 801 may use the time stamp field to select CDRs of a relevant/desired time period. The resulting frequency table may thus include a source-destination frequency record for each communication edge including: a source field identifying the source node; a destination field indicating the destination node; a frequency node indicating a number of communications initiated by the source node that are received by the destination node; and a cumulative duration indicating sum of the durations of the individual communications initiated by the source node that are received by the destination node.

Operations of generating a degree table for a network of nodes are discussed in greater detail with respect to FIG. 3B. The degree table may include a node-degree record for each node in the network, and each node-degree record may thus include a node identification field identifying the node (e.g., a telephone number of the node), an indegree field, an outdegree field, and a degree field. At block 351, processor 801 may initialize elements/fields (e.g., indegree field, outdegree field, and degree field) to zero in the degree table for each node.

At block 353, processor 801 may read an initial source-destination frequency record from the frequency table discussed above with respect to FIG. 3A. For the node-degree record with the node identification field matching the destination (dst) field of the current source-destination frequency record, processor 801 may increase the indegree field for the matching node-degree record at block 355. For the node-degree record with the node identification field matching the source (src) field of the current source-destination frequency record, processor 801 may increase the outdegree field for the matching node-degree record at block 357. For a given source-destination frequency record, an indegree for the destination node is increased, and an outdegree for the source node is increased.

According to some embodiments, processor 801 may increment (i.e., increase by 1) the respective indegree/outdegree field at blocks 355/357 so that each indegree field indicates a number of communication edges for which the respective node is a destination and so that each outdegree field indicates a number of communication edges for which the respective node is a source. According to some other embodiments, processor 801 may increase the respective indegree/outdegree field at blocks 355/357 by the frequency of the current source-destination frequency record so that each indegree field indicates a number of communications for which the respective node is a destination and so that each outdegree field indicates a number of communications for which the respective node is a source.

At block 359, processor 801 may determine if there are additional unprocessed source-destination frequency records from the frequency table. If not all of the source-destination frequency records have been processed at block 359, processor 801 reads a next source-destination frequency record at block 361 and repeats operations of blocks 355, 357, and 359 until all of the source-destination frequency records from the frequency table have been processed at block 359. For each next source-destination frequency record from block 361, processor 801 may increase the indegree field for the node-degree record with the node identification field matching the destination (dst) field of the current source-destination frequency record at block 355, and processor 801 may increase the outdegree field for the node-degree record with the node identification field matching the source (src) field of the current source-destination frequency record at block 357. As discussed above, increasing the indegree/outdegree fields may include incrementing (increasing by one) the respective field for each matching source-destination frequency record (to count a number of communication edges), or increasing the respective field by the frequency of the respective source-destination frequency record (to count a number of communications).

Processor 801 may repeat operations of blocks 361, 355, 357, and 359 until all source-destination frequency records of the frequency table have been processed. Once the indegree and outdegree fields of the degree table have been completed at block 359, processor may calculate a degree for each node at block 363. More particularly, the degree for each node-degree record may be calculated as the sum of the indegree and the outdegree for the node-degree record.

The resulting degree table may thus include a node-degree record for each node of the network including: a node field indentifying the node (e.g., a telephone number for the node); a community field (mod) identifying a community to which the node belongs; an indegree field; an outdegree field; and a degree field. If blocks 355 and 357 increment the respective indegree and outdegree fields for matching source-destination frequency records, the final values of the indegree, outdegree, and degree fields represent numbers of communication edges. If blocks 355 and 357 increase the indegree and outdegree fields by the frequencies of the matching source-destination frequency records, the final values of the indegree, outdegree, and degree fields represent numbers of communications.

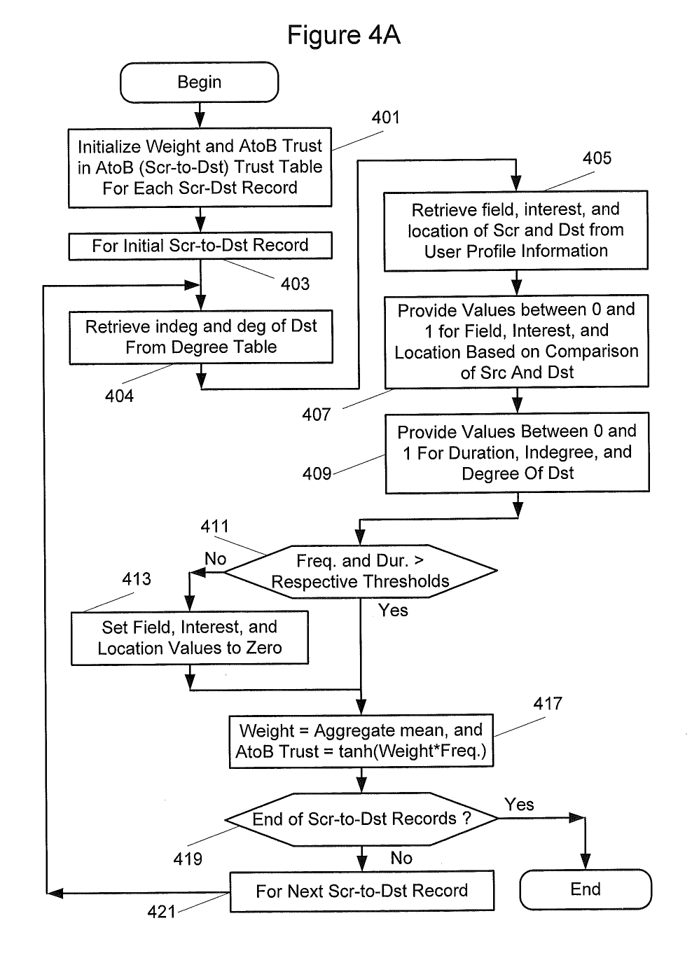

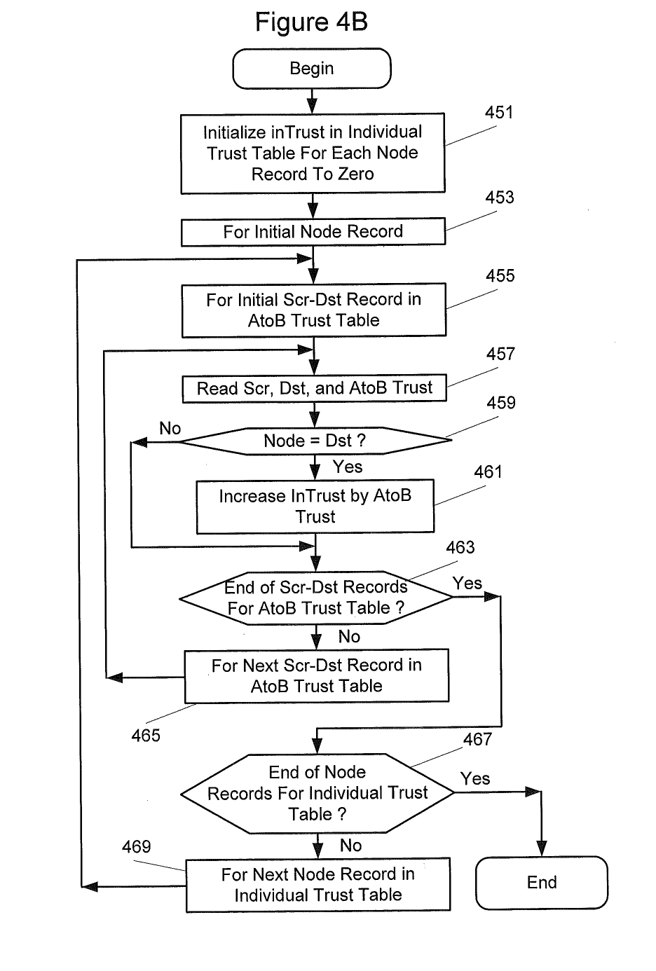

Operations of generating an AtoB trust table for a network of nodes are discussed in greater detail with respect to FIG. 4A. The AtoB table may include a source-to-destination record (also referred to as an AtoB record) for each source-to-destination node pair in the network, and each source-to-destination record of the AtoB trust table may thus include a source field identifying the source node (e.g., a telephone number of the source node), a destination field identifying the destination node (e.g., a telephone number of the destination node), a weight field, and an AtoB trust value. Here, AtoB indicates a source-to-destination communication edge where node A is the source node of the edge, and node B is the destination node of the edge. At block 401, processor 801 may initialize elements/fields (e.g., weights and AtoB trust values) to zero in the AtoB trust table for each source-to-destination record.

At block 403, processor 801 may begin with a first source-to-destination record at block 403 as the current source-to-destination record. At block 404, processor 801 may retrieve the indegree and the degree of the destination node for the current source-to-destination record from the degree table discussed above with respect to FIG. 3B. At block 405, processor may retrieve field, interest, and/or location information for the source and destination nodes from user profile information (e.g., stored in core network 70). At block 407, processor 801 may provide a value between 0 and 1 for each of field, interest, and/or location based on comparing field, interest, and/or location information of the source and destination nodes for the current source-to-destination record. At block 409, processor 801 may provide a value between 0 and 1 for each of duration, indegree, and degree for the destination node of the current source-to-destination record.

If the frequency of the respective source-to-destination record from the frequency table does not exceed a frequency threshold (e.g., a frequency of 1) and/or the duration of the respective source-to-destination record from the frequency table does not exceed a duration threshold (e.g., a duration of 100 seconds) at block 411, the field, interest, and location values may be set to zero at block 413. If the frequency of the respective source-to-destination record from the frequency table does exceed the frequency threshold (e.g., a frequency of 1) and the duration of the respective source-to-destination record from the frequency table does exceed the duration threshold (e.g., a duration of 100 seconds) at block 411, the field, interest, and location values may be maintained from block 407.

At block 417, processor 801 may calculate the weight for the current source-to-destination record as an aggregate mean of the duration, indegree, degree, field, interest, and location values discussed above with respect to blocks 404, 405, 507, 409, 411, and 413. At block 417, processor 801 may also calculate an AtoB trust value for the source-to-destination record as the hyperbolic tangent of the product of the weight and the frequency or:

AtoB trust=tan h(Weight*Frequency).

At block 419, processor 801 may determine if there are additional unprocessed source-to-destination records of the AtoB trust value table to be processed. If not all of the source-to-destination records have been processed at block 419, processor 801 may initiate processing for a next source-to-destination record at block 421 and repeat operations of blocks 404, 405, 407, 409, 411, 413, 417, and 419 until all of the source-to-destination records of the AtoB trust table have been processed at block 419, and all source-to-destination records of the AtoB trust table have been populated with AtoB trust values.

The resulting AtoB trust table may thus include a source-to-destination record for each communication edge, and each source-to-destination record may include a source field identifying the source node, a destination field identifying the destination node, a weight field providing a weight as discussed above with respect to block 417, and an AtoB trust field providing an AtoB trust value indicating a trust of the source node toward the destination node.

Operations of generating an individual trust table for a network of nodes are discussed in greater detail with respect to FIG. 4B. The individual trust table may include a node record for each node in the network, and each node record of the individual trust table may include a node field identifying the node (e.g., a telephone number of the node), and an individual trust value for the node. At block 451, processor 801 may initialize the individual trust value to zero for each node record in the individual trust table.

For an initial node record at block 453, processor 801 may initiate calculation of an individual trust for the node of the initial node record. At block 457, processor 801 may read the source, destination, and AtoB trust values of a first source-to-destination record of the AtoB trust table. If the node of the current node record matches the destination of the current source-to-destination record at block 459, the individual trust value of the current node record is increased by the AtoB trust value of the current source-to-destination record. If the node of the current node record does not match the destination of the current source-to-destination record at block 459, the individual trust value of the current node record remains unchanged.

At block 463, processor 801 may determine if there are additional source-to-destination records of the AtoB trust value table to be processed for the current node record of the individual trust table. If not all of the source-to-destination records have been processed for the current node record at block 463, processor 801 may initiate processing for a next source-to-destination record at block 465 and repeat operations of blocks 457, 459, 461, and 463 until all of the source-to-destination records of the AtoB trust table have been processed for the current node record at block 463, and an individual trust value has been calculated for the current node record. Stated in other words, the individual trust value for the initial node record may be calculated as a sum of AtoB trust values of communication edges for which the node of the node record is the destination.

Once all entries of the AtoB trust table have been processed for a current node record of the individual trust table, processor 801 determines at block 467 if all node records of the individual trust table have been processed. If not, processor 801 may initiate processing for a next node record in the individual trust table at block 469. Operations of blocks 455, 457, 459, 461, 463, 465, 467, and 469 may thus be repeated until an individual trust value is calculated for each node of the network. As discussed above, the individual trust value for a node may be calculated as a sum of all of the AtoB trust values for communication edges for which the respective node is a destination. The resulting individual trust table may thus include a node record for each node of the network, and each node record may include a node field identifying the node, a community field (mod) identifying a community to which the node belongs, and an individual trust value for the node.

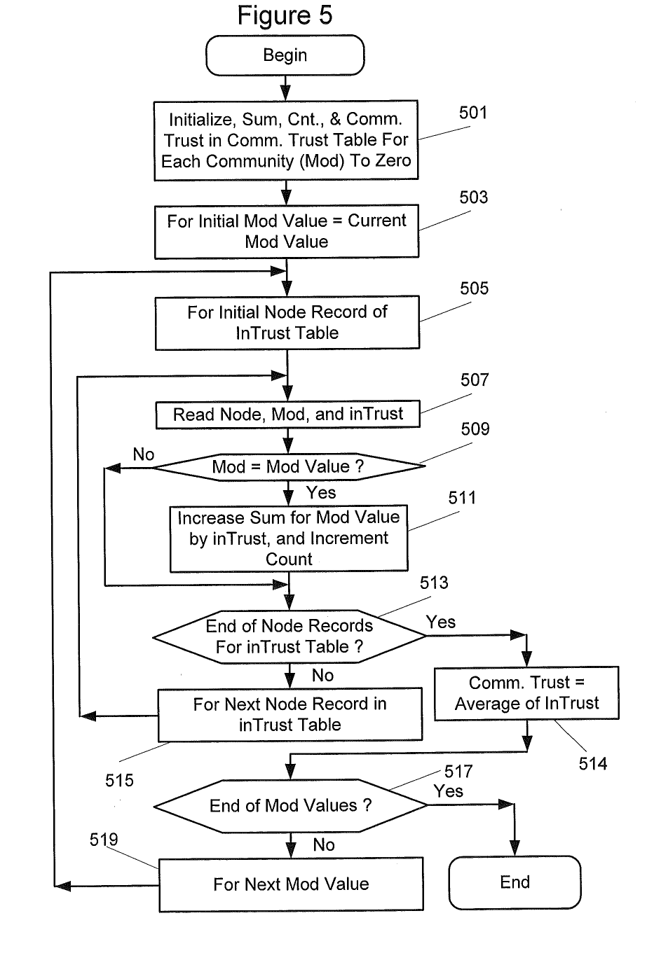

Community trust values may then be calculated and provided in a community trust table as discussed below with respect to the flow chart FIG. 5. The community trust table may include a record for each community of nodes in the network, and each record may include a community field (providing a communication identification, also referred to as mod) identifying the community, a sum, a count, and a community trust value. At block 501, processor may initialize all of the sum, count, and community trust values to zero. At block 503, processor 801 may initiate processing for an initial community record including an initial community identification or mod. At block 505, processor 801 may begin with an initial node record of the individual trust (intrust) table discussed above with respect to FIG. 4B. At block 507, processor 801 may read the node identification, the community identification (mod), and the individual trust value of the current node record. If the community identification (mod) of the current node record matches the community identification of the current community record at block 509, the sum of the current community record may be increased by the individual trust of the current node record and the count may be incremented (increased by 1). If the community identification (mod) of the current node record does not match the community identification of the current community record at block 509, the sum and count for the current community record does not change.

At block 513, processor may determine if all of the node records from the individual trust table have been processed for the current community record. If not, processor 801 may initiate processing a next node record from the individual trust table for the current community record. Operations of blocks 507, 509, 511, 513, and 515 may thus be repeated until all node records have been processed for a community record so that the sum is a sum of all individual trust values for nodes of the community and count is a number of nodes of the community. Once all of the node records have been processed for the current community at block 513, a community trust value for the community may be calculated as an average of the individual trust values of all of the nodes of the community at block 514.

At block 517, processor 801 may determine if the community trust values have been calculated for all communities of the network. If not, processor 801 may initiate processing for a next community at block 519, and operations of blocks 505, 507, 509, 511, 513, 515, 514, 517, and 519 may be repeated until community trust values have been calculated for all communities of the network. As discussed above, each community trust value may thus be calculated as an average of individual trust values of the node of that community.

Moreover, the nodes of different communities represented in a frequency table discussed above with respect to FIG. 3A may be mutually exclusive so that an individual trust value of a node is used in the calculation of a community trust value of only one community as discussed above with respect to FIG. 5. For example, for a given frequency table based on a given time period nodes of communities may be mutually exclusive. Different communities of nodes, however, may be determined for different time periods.

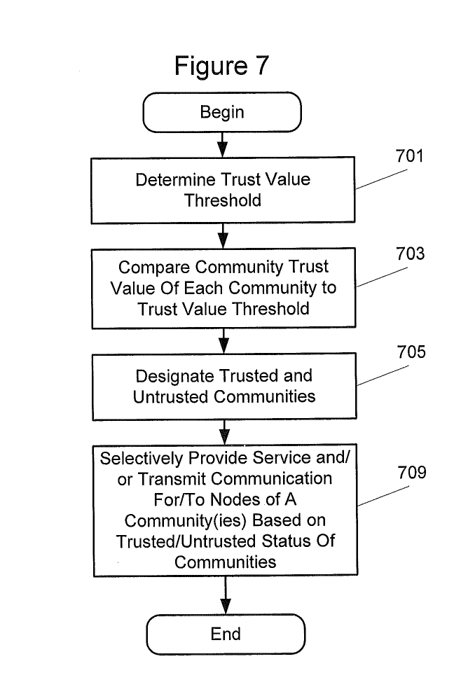

FIG. 7 is a flow chart illustrating operations of processor 801 making use of the community trust values discussed above. At block 701, processor may determine a community trust value threshold used to distinguish relatively trusted communities of nodes and relatively untrusted communities of nodes. At block 703, processor may compare the community trust value of each community with the community trust value threshold. At block 705, processor 801 may designate communities having community trust values exceeding the trust value threshold as “trusted” communities, and processor 801 may designate communities having trust values less than the trust value threshold as “untrusted” communities. At block 709, processor 801 may selectively provide service and/or transmit communication for/to nodes of a community(ies) based on trusted/untrusted status of respective communities.

In other words, processor 801 may compare trust values of different communities, and responsive to differences in community trust values, individual nodes, users, customers, etc. of one community of nodes may be treated differently than individual nodes, users, customers, etc. of another community of nodes. For example, a service may be selectively provided for nodes of a first community without providing the service for nodes of a second community responsive to a difference between community trust values of the first and second communities. In another example, a communication may be selectively transmitted for nodes of the first community without transmitting the communication for nodes of the second community responsive to a difference between community trust values of the first and second communities.

Based on the average trust scores of different communities of nodes, communities of nodes may be categorized into two or three (or more) classes of communities (e.g., using one threshold to define low and high trust communities, or using two thresholds to define low, medium, and high trust communities). Depending on demand, need, or other factors, the network service provider (also referred to as the network operator) may approach the different classes of communities differently for cross selling and/or up-selling activities. The network service provider, for example, may selectively target a low trust community (without targeting a high trust community) with cross selling and/or up-selling activities (e.g., transmitting marketing communications to/for nodes of the low trust community) to improve an average trust score of the low trust community, and/or the network service provider may selectively target a low trust community (without targeting a high trust community) by introducing one or more value added services and/or free/discounted services for nodes of the low trust community. The network service provider may selectively consider a high trust community (without considering a low trust community) for trial and/or high end promotions, because a greater number of loyal customers may already be present in the high trust community. Even churn or loyalty may be addressed with suitable recommendations (i.e., communications to/for nodes of a respective community) based on a trust class of the community of nodes.

A network service provider may thus selectively transmit a communication to/for nodes of a high trust community without transmitting the communication to/for nodes of a low trust community, or a network service provider may selectively transmit a communication to/for nodes of a low trust community without transmitting the communication to/for nodes of a high trust community. Such a communication may be provided as: an electronic communication (e.g., a text message, an e-mail, etc.) transmitted directly to the respective nodes (e.g., to wireless terminals of the network); a print communication (e.g., post office mail) transmitted to physical addresses (e.g., billing addresses) associated with respective nodes; an e-mail transmitted to e-mail addresses associated with respective nodes; additional information provided in a billing statement (electronic or print) sent to users of respective nodes; etc.

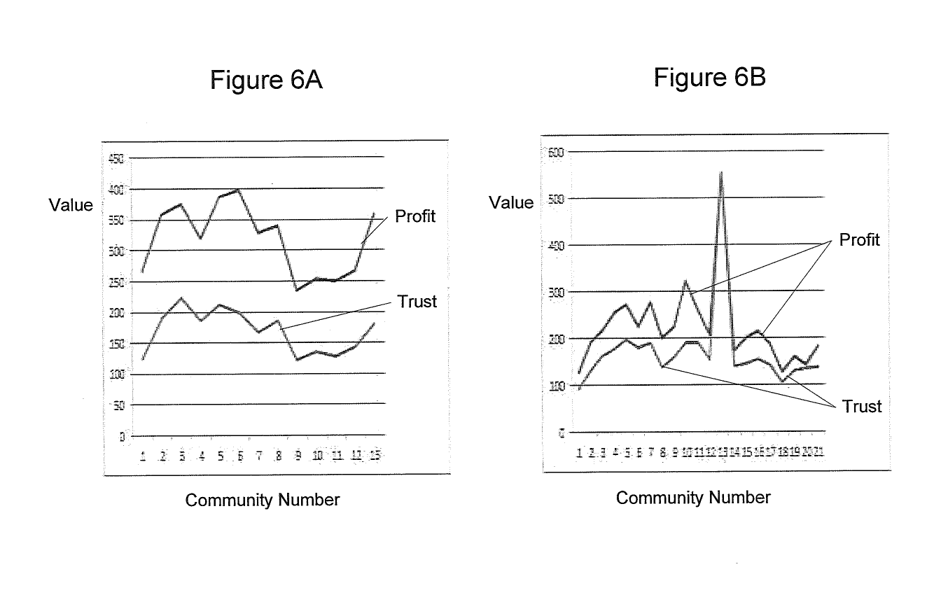

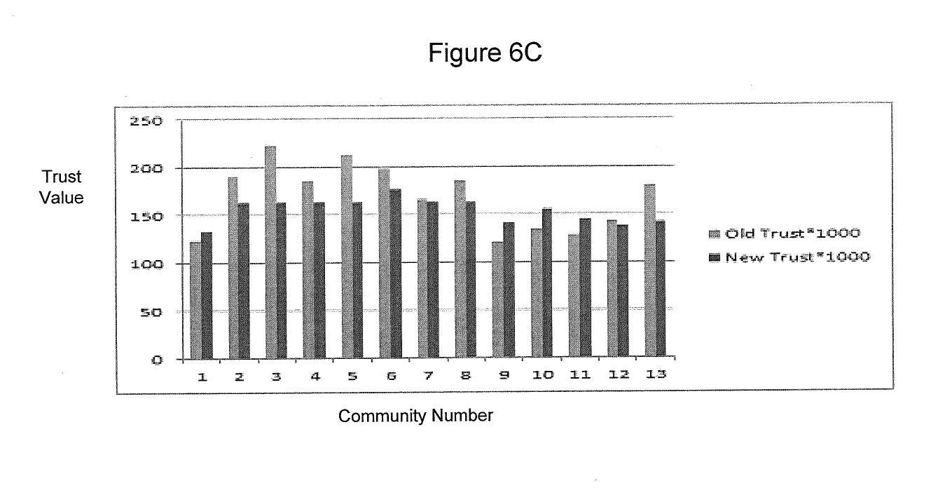

FIGS. 6A and 6B are graphs illustrating examples of trust values and costs associated with different communities of nodes (identified by community number) for different time periods in accordance with the data provided in Table 1 below.

TABLE 1

| | Time Period 1 | Time Period 2 |
|---|---|---|
| Number of | 65536 | 65536 |
| Communications | | |
| Number of Nodes in | 39324 | 32441 |
| the Network | | |
| Number of | 48290 | 50844 |
| Unique Edges | | |
| Average Number | 3015 | 1410 |
| of Nodes | | |
| per Community | | |
| Node Trust | 0 to 0.98851 | 0 to 0.994795 |
| Number of | 13 | 21 |
| Communities | | |
| Community Trust | 0.121622 to 0.224038 | 0.093482 to 0.55266 |
| Average Cost | 234.3033 to 398.2707 | 128.0732 to 556.018 |

In table 1, input fields from the database of CDRs used to calculate trusts include calling party, called party, date, duration, billing number, cost, tele exchange, and call type, and the community trust values are multiplied by 1000 for the purpose of scaling for inclusion in the graphs of FIGS. 6A and 6B. In particular, FIG. 6A is based on data from time period 1, and FIG. 6B is based on data from time period 2. Moreover, FIGS. 6A and 6B show that trust values and Profits earned by the network service provider (also referred to as the network operator) may vary directly such that communities with higher trust values generate higher profits, and communities with lower trust values generate lower portions of profits.

FIG. 6C is a graph illustrating classification of communities of nodes based on Trust values. For each community (identified by the community number on the x-axis), the first bar represents the trust value during the first time period of Table 1 (Old Trust*1000), and the second bar represents the trust value during the second time period of Table 1 (New Trust*1000). The graph of FIG. 6C illustrates that trust values may drop over time for communities that are relatively less trusted (e.g., communities 2, 3, 4, 5, 6, 8, and 13), while trust values may improve over time for relatively more trusted communities (e.g., communities 1, 9, 10, and 11).

According to some embodiments disclosed herein, evaluating trust for nodes and/or communities of nodes in a cellular network may provide information useful for the network operator/provider to analyze the business, customer behavior, and/or services, including:
identifying features of trust in a cellular telecom network;
determining existence of members/nodes as a single group for a longer period of time;
generating improved profit for a network operator (not only calls, but also other value added services)
identifying frequent communications among community/group members/nodes;
determining how quickly a new member/node can communicate with others by rapidly building trust or distrust; and/or
understand the presence of a greater number of strong nodes in a single community. Evaluating Trust can be useful, for example, to:
understand community behavior(s);
determine how information flows in a network;
assess the credibility of information; and/or
allow service providers to identify possible churners.
   This knowledge may allow a network operator (also referred to as service providers) to devise strategies to retain customers or at least understand which customers trust other customers who churned out of the network.

In the above-description of various embodiments of present inventive concepts, it is to be understood that the terminology used herein is for the purpose of describing particular embodiments only and is not intended to be limiting of the inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions (also referred to as program code) that are performed by one or more computer circuits. These computer program instructions (also referred to as program code) can be provided to a processor circuit (also referred to as a processor) of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions can also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium can include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions can also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of present inventive concepts can be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks can occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of present inventive concepts. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of present inventive concepts. All such variations and modifications are intended to be included herein within the scope of present inventive concepts. Accordingly, the above disclosed subject matter is to be considered illustrative, and not restrictive, and the appended claims are intended to cover all such modifications, enhancements, and other embodiments, which fall within the spirit and scope of present inventive concepts.

That which is claimed is:

1. A method of evaluating trust in a network, the method comprising:
defining a community of nodes of the network from a larger set of nodes of the network;
generating a respective individual trust value for each node of the community of nodes; and
generating a community trust value based on the individual trust values of nodes of the community.

2. The method of claim 1 wherein generating the community trust value comprises generating the community trust value as an average of the individual trust values of the nodes of the community.

3. The method of claim 1 wherein defining the community comprises defining a first community of nodes, and wherein generating the community trust value comprises generating a first community trust value based on the individual trust values of the nodes of the first community, the method further comprising:
defining a second community of nodes from the larger set of nodes operating in the network;
generating a respective individual trust value for each node of the second community of nodes; and
generating a second community trust value based on the individual trust values of nodes of the second community.

4. The method of claim 3 further comprising:
responsive to a difference between the first and second community trust values, selectively providing a service for nodes of the first community without providing the service for nodes of second community.

5. The method of claim 3 further comprising:
responsive to a difference between the first and second community trust values, selectively transmitting a communication for nodes of the first community without transmitting the communication for nodes of second community.

6. The method of claim 3 wherein nodes of the first and second communities are mutually exclusive.

7. The method of claim 1 wherein defining the community of nodes comprises defining a first community of nodes for a first time period of a day, wherein generating the respective individual trust values comprises generating the respective individual trust values for each node of the first community of nodes for the first time period of the day, and wherein generating the community trust value comprises generating a first community trust value for the first time period of the day, the method further comprising:
defining a second community of nodes from the larger set of nodes operating in the network for a second period of the day, wherein at least one node of the first and second communities is the same and wherein some nodes of the first and second communities are different;
generating a respective individual trust value for each node of the second community of nodes for the second time period of the day; and
generating a second community trust value based on the individual trust values of nodes of the second community for the second time period of the day.

8. The method of claim 7 wherein a first node is included in the first and second communities of nodes and wherein a second node is included in the first community and excluded from the second community.

9. The method of claim 8 wherein a third node is included in the second community and excluded from the first community.

10. The method of claim 1 wherein the network comprises a mobile communication network including a plurality of base stations and wherein each of the nodes comprises a respective wireless terminal configured to communicate over a wireless interface with the base stations of the mobile communication network.

11. The method of claim 1 wherein generating a respective individual trust value for a node of the community comprises:
determining an indegree for the node as a number of communications received by the node, and
determining a degree for the node as a total number of communications initiated and received by the node,
wherein generating the respective individual trust value for the node comprises generating the respective individual trust value for the node based on the indegree and degree for the node.

12. The method of claim 1 wherein generating a respective individual trust value for a first node of the community comprises:
determining a frequency as a number of communications initiated by a second node that are received by the first node,
comparing user profiles of the first and second nodes, and
determining a second to first node trust value based on the frequency and the comparing user profiles of the first and second nodes,
wherein generating the respective individual trust value for the first node comprises generating the respective individual trust value for the first node based on the second to first node trust value.

13. The method of claim 12, wherein the frequency is a first frequency and wherein generating a respective individual trust value for a first node of the community further comprises,
determining a second frequency as a number of communications initiated by a third node that are received by the first node,
comparing user profiles of the first and third nodes, and
determining a third to first node trust value based on the second frequency and the comparing user profiles of the first and second nodes,
wherein generating the respective individual trust value for the first node comprises generating the respective individual trust value for the first node based on the second to first node trust value and the third to first node trust value.

14. The method of claim 13 wherein generating the respective individual trust value for the first node comprises summing the second to first node trust value and the third to first node trust value.

15. The method of claim 12 wherein comparing user profiles comprises comparing fields of work associated with users of the first and second nodes, interests associated with users of the first and second nodes, and/or comparing locations associated with the first and second nodes.

16. The method of claim 12 wherein generating the second to first node trust value comprises generating a weight based on comparing the user profiles of the first and second nodes and generating a product of the weight and the frequency.

17. The method of claim 16 wherein generating the second to first node trust value further comprises performing a hyperbolic tangent function on the product of the weight and the frequency.

18. A computer system comprising:
a processor; and
memory coupled to the processor and comprising computer readable program code that when executed by the processor causes the processor to perform operations comprising:
defining a community of nodes of the network from a larger set of nodes of the network;
generating a respective individual trust value for each node of the community of nodes; and
generating a community trust value based on the individual trust values of nodes of the community.

19. The computer system of claim 18 wherein generating the community trust value comprises generating the community trust value as an average of the individual trust values of the nodes of the community.

20. The computer system of claim 18 wherein defining the community comprises defining a first community of nodes, and wherein generating the community trust value comprises generating a first community trust value based on the individual trust values of the nodes of the first community, wherein the memory further comprises computer readable program code that when executed by the processor causes the processor to perform operations comprising:
defining a second community of nodes from the larger set of nodes operating in the network;
generating a respective individual trust value for each node of the second community of nodes; and
generating a second community trust value based on the individual trust values of nodes of the second community.
